(19) United States
(12) Patent Application Publication
(10) Pub. No.: US 2025/0298673 A1
(43) Pub. Date: Sep. 25, 2025

(54) Persistent Multi-Instance GPU Partitions

(71) Applicant: Rakuten Symphony, Inc., Tokyo (JP)

(72) Inventors: Tushar Anil Doshi, Santa Clara, CA (US); Shubham Yewalekar, Bangalore (IN); Madhura Gaunekar, San Jose, CA (US)

(21) Appl. No.: 18/250,708

(22) PCT Filed: Dec. 14, 2022
(86) PCT No.: PCT/US2022/052887

§ 371 Date: Apr. 26, 2023

(51) Int. Cl. G06F 9/50

(52) U.S. Cl. CPC G06F 9/5077

(57) ABSTRACT

A method comprising steps for partitioning a GPU and saving partition data to a database. The steps include providing a node comprising one or more applications. The steps further include providing a GPU, dividing the GPU into one or more GPU instances, wherein each GPU instance is associated with at least one of the one or more applications, saving partition data pertaining to the one or more GPU instances to a file, and saving the file to a database.

### TECHNICAL FIELD

The present disclosure relates generally to graphics processing units (GPUs) and the partitioning thereof, and specifically relates to actions associated with preserving information about those partitions across a server restart or similar occurrence.

### SUMMARY

A method comprising steps for partitioning a GPU and saving partition data to a database. The steps may include providing a node comprising one or more applications. The steps may further include providing a GPU, dividing the GPU into one or more GPU instances, wherein each GPU instance is associated with at least one of the one or more applications, saving partition data pertaining to the one or more GPU instances to a file, and saving the file to a database.

### BACKGROUND

Graphics Processing Units (GPUs) are popular within the industry as optimal choices to run artificial intelligence (AI), machine learning (ML) and deep learning (DL) workloads. These workloads require massive amounts of data, both ultra-high speed and parallel processing, along with flexibility and high availability. It is clear that high-performance computing (HPC) with graphics processing unit (GPU) systems are required to support cutting-edge workloads. Therefore, cloud platforms must be enhanced to get the most out of them.

Modern cloud platforms rely on GPUs for performance in managing their workloads. As GPUs have increased in performance many workloads underutilize and waste this additional performance. Sharing a GPU provides a solution for a system to optimize performance gained from each GPU within the system. Creating partitions on each GPU allows a system to manage multiple workloads in parallel across each instance. A single node on a cloud platform may utilize one or more GPUs to facilitate its workload.

However, when nodes reboot, the partitions on the GPU are lost. This causes applications to stall and be unable to perform their tasks and can lead to issues in system stability and throughput. Applications effectively stall until a user notices the problem and manually recreates new partitions and assigns those partitions back to the applications that were using them. There is a need to find a way to preserve these GPU partitions across reboots to maintain availability of applications and these resources and to reduce the downtime of systems after partition loss and allow applications to come up automatically after reboot.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a schematic diagram of an overall view of cloud-network system featuring GPU with partitions.

FIG. 2 shows a schematic diagram of a GPU with partitions.

FIG. 3 shows a schematic diagram of a GPU diagram with partitions mapped to applications.

FIG. 4 shows a schematic diagram of a node having a GPU with partitions being backed up to database.

FIG. 5 shows a schematic diagram of a node having multiple GPUs with multiple partitions being backed up to database.

FIG. 6 shows a schematic diagram of a node having changed to add an additional partition to the GPU, prompting a backup to the database.

FIG. 7 shows a schematic diagram of a node having partitions restored from database.

FIG. 8 shows a schematic diagram of a node having multiple GPUs with partitions being restored from a database.

FIG. 9 shows a schematic diagram of a node with MIG partitions having been restored from a backup remapping to applications in order to provide GPU compute resources to those applications.

FIG. 10 shows flow chart diagram of method steps for partitioning a GPU and backing up that partition data to a database.

FIG. 11 shows flow chart method diagram of other method steps for backing up partition data to a database and retrieving that partition data to create new GPU partitions.

FIG. 12 shows a schematic diagram of an example computer device.

### DETAILED DESCRIPTION

Graphics Processing Units (GPUs) today are capable of having their resources subdivided, as what is referred to as Multi-instance GPUs (MIG). MIG capability allows a single GPU to be partitioned into separate GPU instances that may be assigned various applications, allowing multiple users or nodes with separate requirements to share resources from a single GPU. Each instance or partition may have its own streaming multiprocessors (SMs), GPU memory, cache, memory bandwidth, etc. Each GPU instance may have a separate, isolated path through a memory system with on-chip crossbar ports, L2 cache banks, memory controllers, and DRAM address busses to allow workloads on each instance to run with consistent throughput and latency without impacting other instances. A GPU instance may be further divided into compute instances. A compute instance may be a smaller subdivision of a GPU instance allowing for finer micromanaging and assignment of a GPU instance's resources. The smallest possible partition of a GPU is called a GPU slice. A GPU slice may comprise a GPU instance having a dedicated memory, and at least one compute instance.

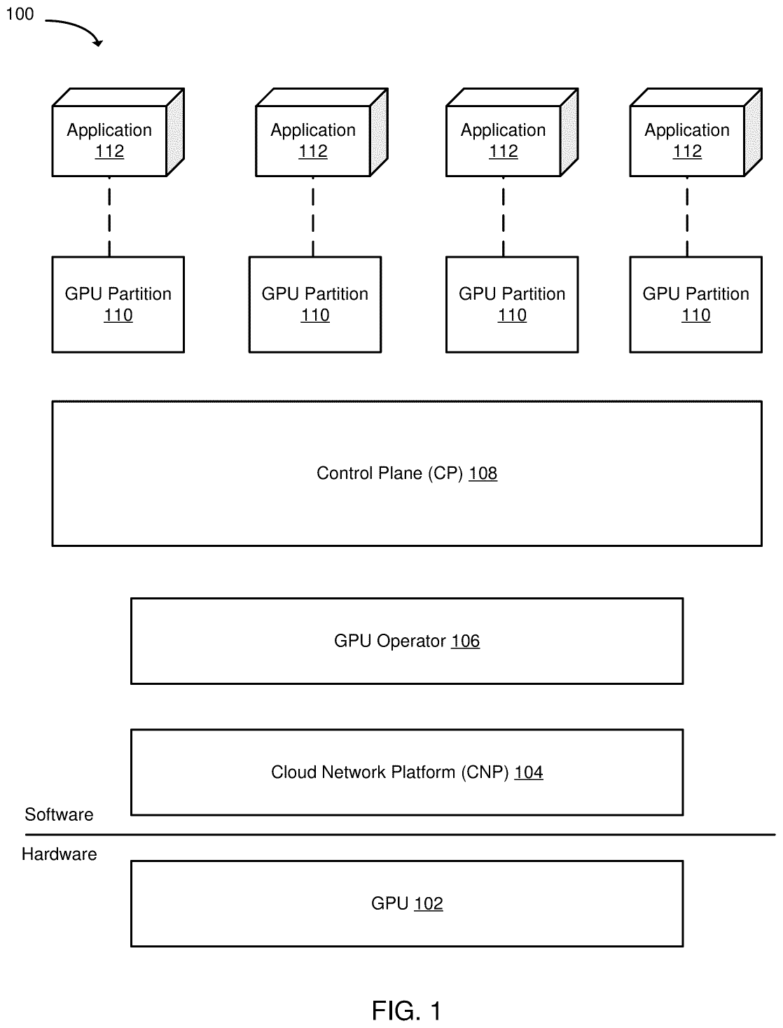

Referring now to the figures, FIG. 1 is a diagram detailing a system 100 stack having a GPU 102 within a Cloud Network Platform (CNP) 104. At the hardware level the system may have one or more physical GPU 102s. MIG-compatible GPUs 102 may be managed by firmware and drivers, and programmatically partitioned from the software layer to provide the partitions utilized by system. These GPUs 102 may be managed at the software level by an operating system running a CNP 104. On the CNP 104 there may be an automated agent or daemon service acting as a GPU operator 106. The GPU operator 106 may allow for the management of configurations and settings of the GPUs 102 within the system. Specifically, the GPU operator 106 may manage drivers, container runtimes, CNP device plugins, and other monitoring functions of the GPUs 102 within the system 100. A Control Plane (CP) 108 may exist to manage the GPU operator 106 and other functions of the CNP 104. The CP 108 may facilitate storage, network, observability, life cycle management (LCM), application programming interfaces (APIs), role-based account control, monitoring, high availability (HA), and more. The CP 108 may additionally manage the providing of system resources to application containers running within the CNP 104. One or more applications 112 running on the CNP 104 may have a need for compute resources to be provided by a GPU 102. In such cases, the CP 108 may be responsible for directing the GPU operator 106 which handles the creation and management of GPU instances 110 created from partitioning GPUs 102 in the system 100. GPU instances 110 may be mapped on a one-to-one basis with each application 112 running on the CNP 104 in some implementations, while in others one application may utilize other combinations of GPU instance 110 resources.

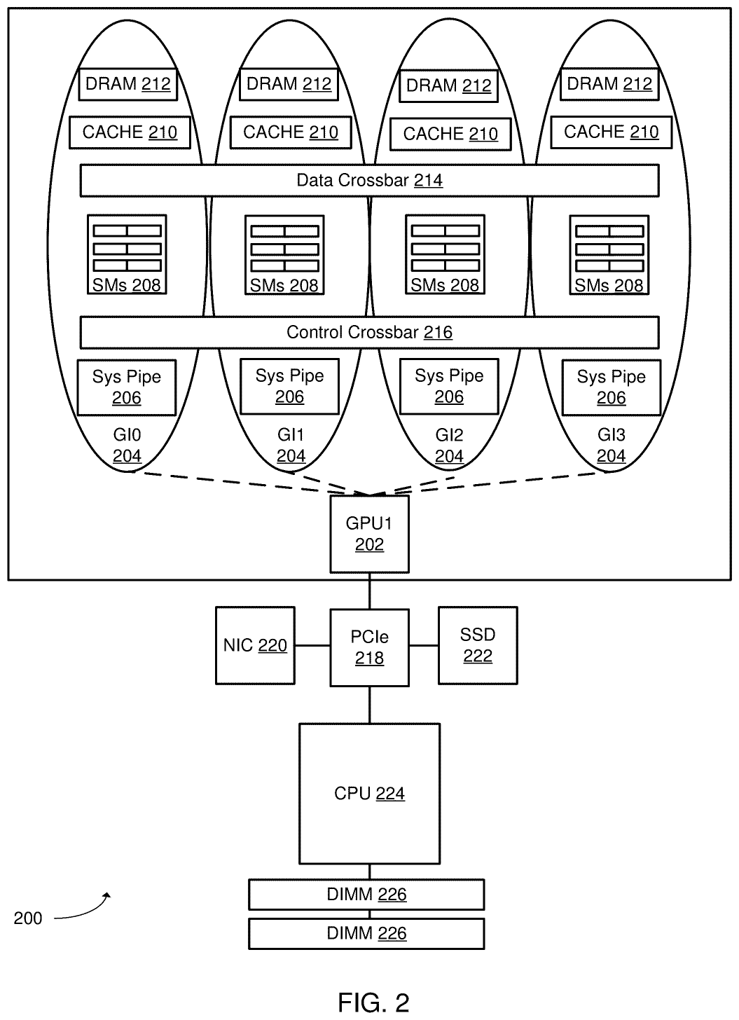

FIG. 2 shows a schematic diagram of an exemplary system at the hardware level 200 comprising a MIG-compatible GPU 202 with partitions. The GPU 202 may be supported by a standard, modern computer system, featuring a peripheral component interconnect express (PCIe) 218 or other compatible mother board interface, a memory such as a solid state drive (SSD) 222 or other compatible memory for providing static memory, and a network interface card (NIC) 220 for network functionality. The system may additionally feature a central processing unit (CPU) 224 supported by one or more dual in-line memory modules (DIMM) 226 or comparable memory for providing random access memory (RAM). Programming instructions performed by the CPU 224 may divide a GPU 202 within the system into one or more partitions, represented as GPU instances 204, thus splitting computing power of the GPU 202 across each instance 204. GPU instances 204 may be uniformly divided or individually specified so long as the sum total of each partition does not exceed the total compute and memory capacity of the GPU 202.

Each GPU instance 204 may comprise virtual structures representing an allocation of the physical resources of the GPU 202. These structures may include a system pipe 206 to facilitate throughput. Each GPU instance 204 may additionally comprise one or more streaming multiprocessors (SMs) 208 which may be responsible for executing compute instructions on the GPU 202. These structures may further include cache banks 210 for caching data, and dynamic random access memory (DRAM) 212 support for the GPU instance 204. Each partition may share a data crossbar 214 and a control crossbar 216 to allow GPU instances 204 to facilitate input and output to and from each GPU instance 204 and out into the rest of the system. By utilizing partitions, each GPU instance 204 may keep their workloads separate, allowing for fault isolation, performance isolation, and memory bandwidth isolation of each instance from other instances on the GPU. This separation allows each GPU instance 204 to process parallel workloads that may operate efficiently without interfering with the operations of other instances.

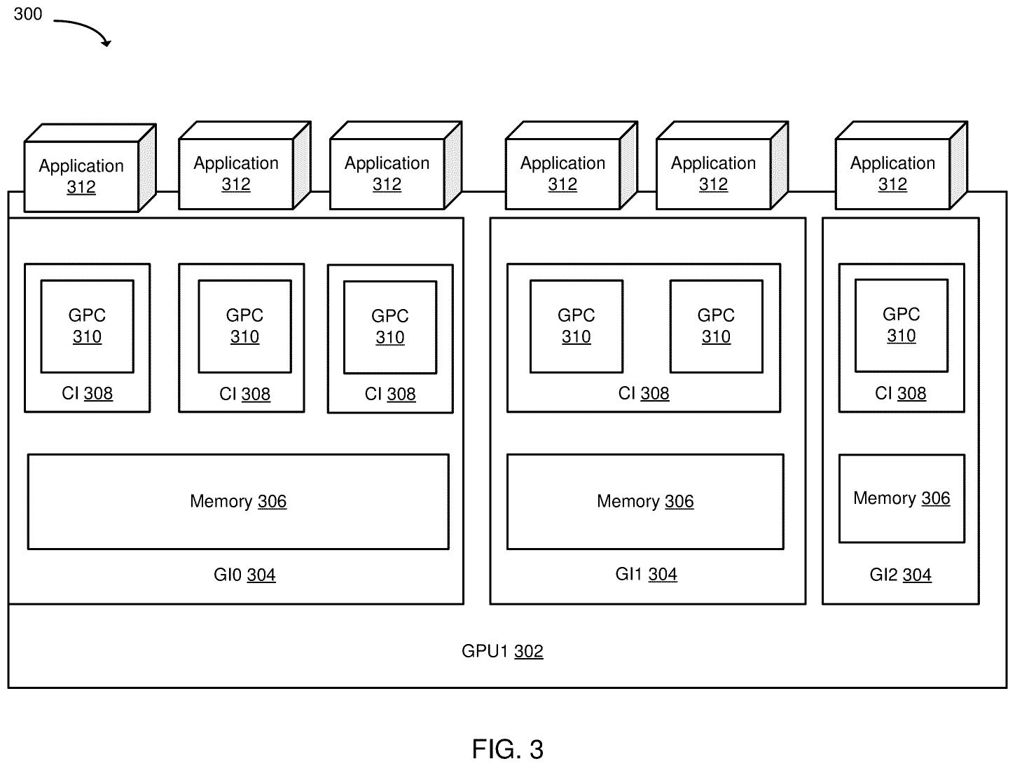

FIG. 3. shows a schematic diagram of an alternative software representation 300 of a MIG-compatible GPU 302 having partitions and providing compute resources to applications 312 running on a CNP (not shown). A GPU partition may comprise one or more GPU instances 304. Each GPU instance 304 may comprise a memory 306 and one or more compute instances 308. The compute instances 308 may comprise GPU processing clusters (GPC) 310. In other implementations one or more GPCs 310 may share a compute instance 308. The GPU 302 may comprise one or more GPU instances 304. Each GPU instance 304 may comprise a memory 306 and one or more compute instances 308. Each compute instance 308 may comprise one or more GPCs 310. The compute instance and GPC together form the compute power to be provided to an application 312, which may be mapped to an application 312 on a one-to-one basis. In some implementations other permutations may be possible, such as one compute instance 308 comprising multiple GPCs 310, one application 312 utilizing multiple compute instances 308, or multiple applications 312 tightly grouped sharing multiple compute instances 308, depending on the user's needs.

A GPU instance 304 may also be referred to as a GPU slice. A GPU slice is a fraction of a GPU combining a GPU memory slice and a GPU SM slice. A GPU memory slice may comprise the smallest fraction of a GPU's memory including corresponding memory controllers and cache. A GPU memory slice may comprise roughly one-eighth of a GPU's total memory resources accounting for both capacity and bandwidth in some implementations, while in others other fractions of total memory resources may be possible. A GPU SM slice may be the smallest fraction of the SMs on the GPU and may be roughly one-seventh of the total number of SMs available on the GPU in some implementations. Other fractions of total memory resources may be supported in other implementations.

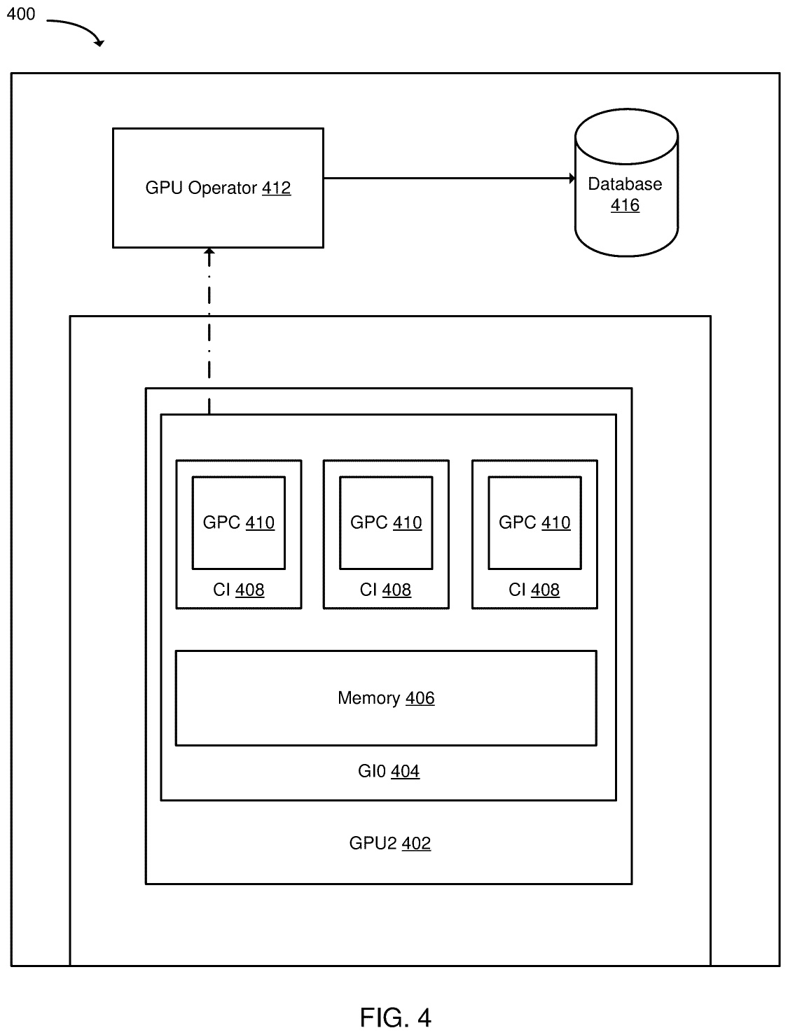

FIG. 4 shows a schematic diagram of a GPU 402 having a GPU instance 404 being saved to a database 416 by a GPU operator 412. MIG partitions divide a whole GPU 402 into multiple small compute units, but the partitions are transient and are lost when the node reboots or otherwise goes offline. To remedy this problem, according to the principles of the present disclosure, information about each GPU 402 and each GPU instance 404 may be stored in a database 416 as partition data. In some implementations a GPU operator, acting as an automated agent, may automatically fetch configuration information from a GPU instance 404 in order to preserve that instance 404 in the database 416. Configuration information may include parameters of the GPU instance, which may include compute size and memory size of each instance as well as the number of instances created on a particular physical GPU. In some implementations a GPU operator may preserve configuration parameters pertaining to each GPU instance 404 being saved such that an agent on the CNP (not shown) may use the parameters to create a new partition at a later time. In other implementations the GPU operator 412 may preserve the configuration parameters of a GPU instance 404 as executable instructions, such that the GPU operator 412 may create a new GPU instance at a later time.

Whenever a node comes back online after a reboot or for another comparable reason, the GPU operator 412 may automatically create new partitions from the same GPU 402 according to the configuration information preserved. By preserving information about GPU instances 404 in a database 416, users may have the ability to persist GPU partitions across reboots or other power outages so the user does not have to create these partitions manually each time, which may reduce application downtime significantly. The GPU operator 412 may monitor the GPU 402 as a whole, individual GPU instances 404, or all the instances on the GPU and save information about the configuration of the GPU instances 404 within the partitions to a configuration file. The database 416 may be on the same node as the GPUs 402 or elsewhere within a system or cluster.

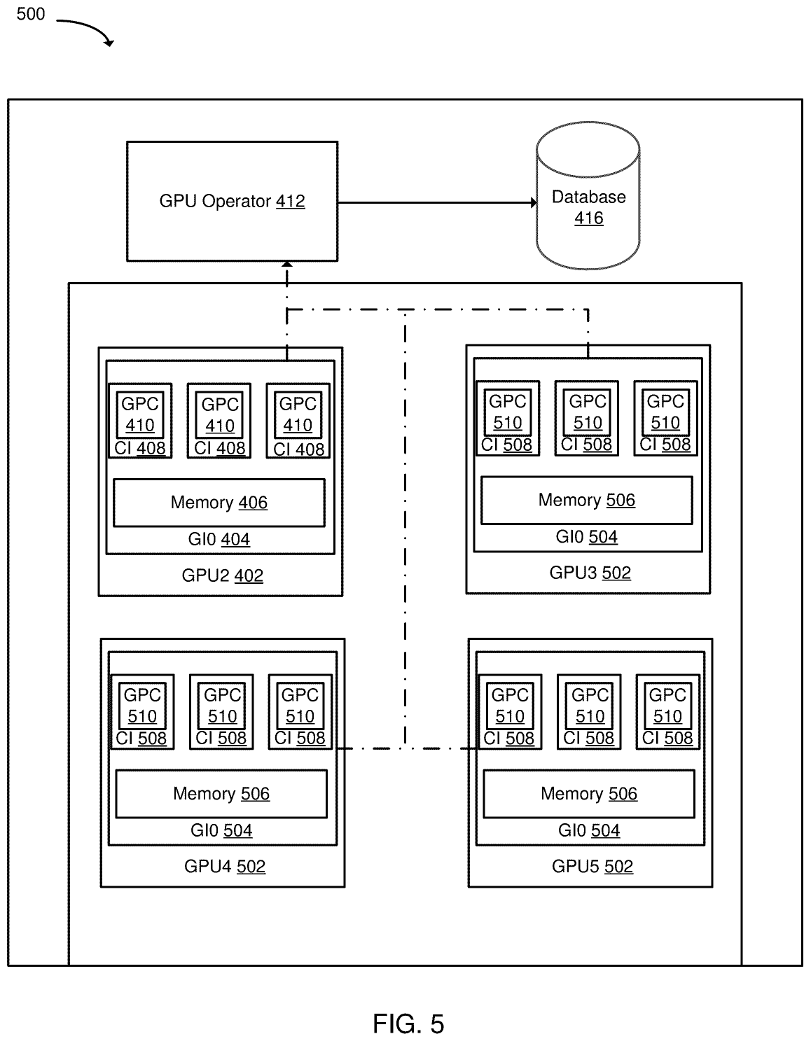

FIG. 5 shows a schematic diagram of multiple GPUs 402, 502 with their own GPU instances 404, 504 being backed up to a database 416. In some implementations a node may comprise more than one GPU 402, 502, and each GPU having one or more instances. Shown in FIG. 5 is an exemplary implementation according to the principles of the present disclosure in which one node hosts four GPUs 402, 502 each having one GPU instance. A GPU operator 412, acting as an agent, may monitor each GPU 402, 502 and periodically preserve information about each active instance 404, 504. Like in FIG. 4, this information, or partition data, may be saved to a database 416 which may be retrieved at a later time to create new GPU instances. In some implementations a GPU operator 412 may back up each GPU instance 404, 504 individually at separate time increments. In other implementations the GPU operator 412 may back up each active instance simultaneously. A user may utilize such staggered updates if one GPU instance 404, 504 experiences more throughput or changes to its configuration than the others. Each GPU instance 404, 504 being saved may each be saved to a unique, individual file in some implementations, while in others a user may group the saved GPU instances 404, 504 into the same file. For example, in one implementation a user may save all GPU instances 404, 504 on the same GPU 402, 502 to its own file. In other implementations a user may save each 404, 504 on a single GPU to its own file. In yet other implementations a user may save each GPU instance 404, 504 on each GPU 402, 502 within the same node to its own file. Those of ordinary skill in the art will appreciate that other permutations are possible.

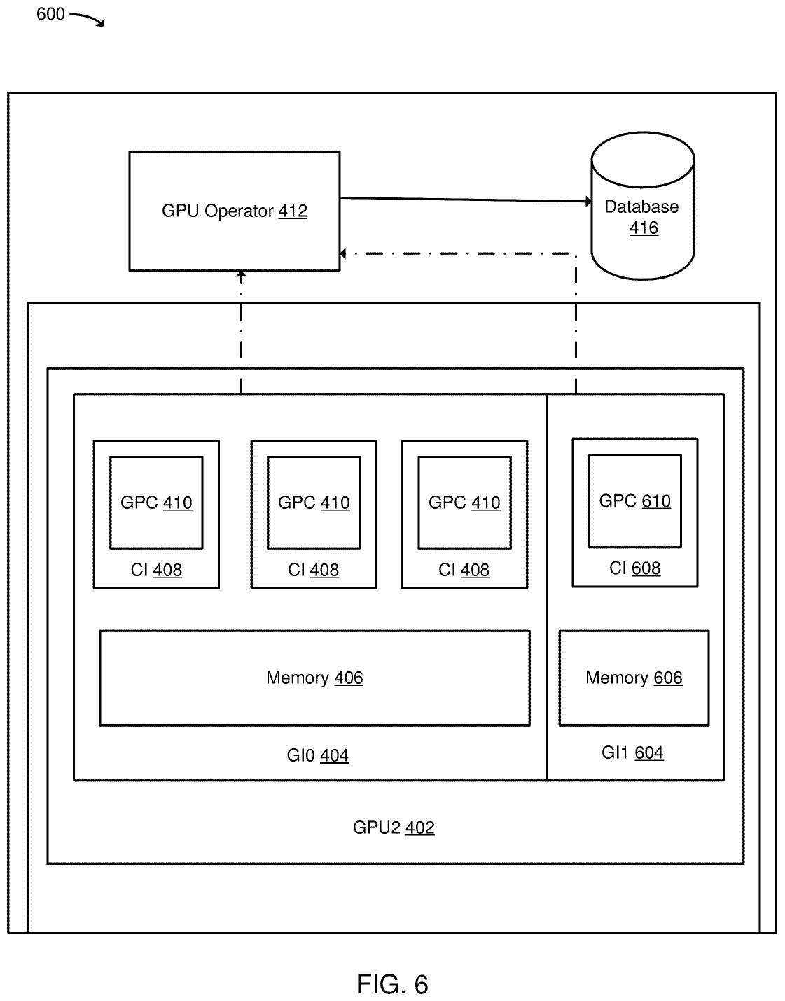

FIG. 6 shows a schematic diagram of a GPU 402 experiencing a change to add an additional GPU instance 604, prompting another back up. In some implementations a user may configure a system to perform a GPU instance 404, 604 back up whenever a change occurs in the number or configuration of GPU instances 404, 604 on a GPU 402. In FIG. 6, in an exemplary implementation, a GPU 402 has been further divided to add a second GPU instance 604. This second GPU instance 604 may have its own memory 606, compute instance 608, and GPC 610 to provide resources to another application. Once this change is detected, the GPU operator 412, acting as an agent, may save data pertaining to the new configuration of the GPU resources to the database 416.

In some implementations, the system may continuously synchronize partition information. Syncs may happen every time there is a change to the state of one or more GPUs or memory allocation by one or more GPUs on a node. A state change may comprise adding or deleting a partition, a change in the amount of compute power given to an application by a partition, adding a new GPU, altering a ratio of compute power within a GPU partition, or other comparable operations. In other implementations, information to be synched may instead be saved to a file intermittently according to a time period specified by a user. A user may use a cache to store this information and have the cache periodically saved to the database in some implementations. When a node reboots, the system may automatically create new GPU partitions so that applications may resume operation seamlessly.

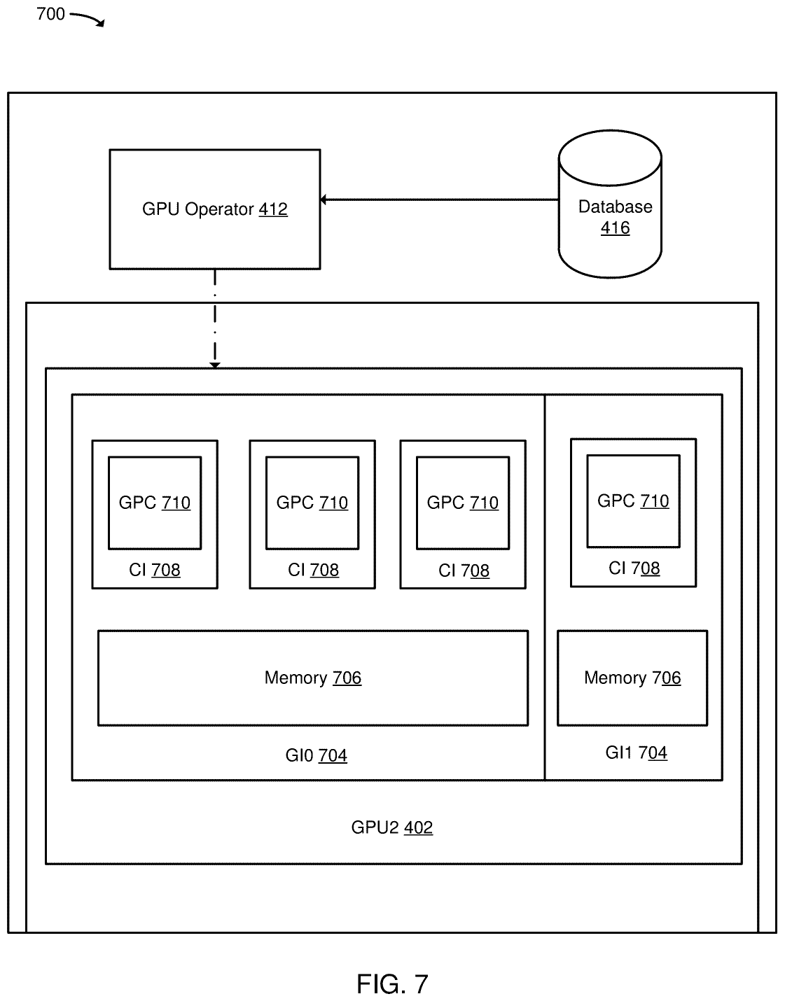

FIG. 7 shows a schematic diagram of GPU instances 704 being “restored” from a backup. If a node reboots or otherwise loses power, any GPU partitions on the node may be deleted. Once that node is back online it may again have a need for the same GPU configuration it had prior to the power loss. The GPU operator 412, acting as an agent, may monitor the status of nodes on the system or cluster periodically. Once a node is back online it may perform a handshake with the GPU operator 412 to notify the GPU operator 412 of the node's restored status. In some implementations, a node may have its own node agent (not shown) running on the node that may communicate the node's status to the GPU operator 412. The node agent may communicate with the GPU operator 412 following a reboot of the node, or in some cases the node agent may periodically communicate with the GPU operator 412 via, for example, keep-alive signals. The GPU operator 412 may then retrieve from the database 416 the configuration or executable file from the database. The node agent may check the retrieved configuration or executable file to determine whether the configuration information matches the current state of the GPU. In some implementations the GPU operator 412 may direct the node agent to recreate the GPU partitions if the then present state of the GPU does not match the retrieved configuration information. In other implementations the GPU operator 412 may direct the node agent to recreate the GPU partition without first cross-checking the state. The GPU operator 412 may perform these steps in order to repartition the GPU 402 to make the resources available for the node's applications.

Partitions may not be saved in a way data from a hard drive is saved and backed up. Instead, the configuration information retrieved from the database 416 may comprise information and instructions on the state of each partition as of the last sync. The GPU is instructed to create new GPU instances 704 to resemble the settings and state of each GPU instance that existed prior to the reboot. Traditionally, each partition must be manually defined and allocated whenever there is a need to partition a GPU 402. However, the GPU operator 412 may be capable of using the information within the configuration file retrieved from the database 416 to automatically create these new partitions programmatically. The configuration file may contain details describing how much compute power in partition, how much DRAM, what L2, what SMs, what Sys Pipe, which application was interfacing, etc. The configuration file may also be backed up in a format understandable as programming language instructions, such that a processor may understand the file and perform the instructions to create the new partitions.

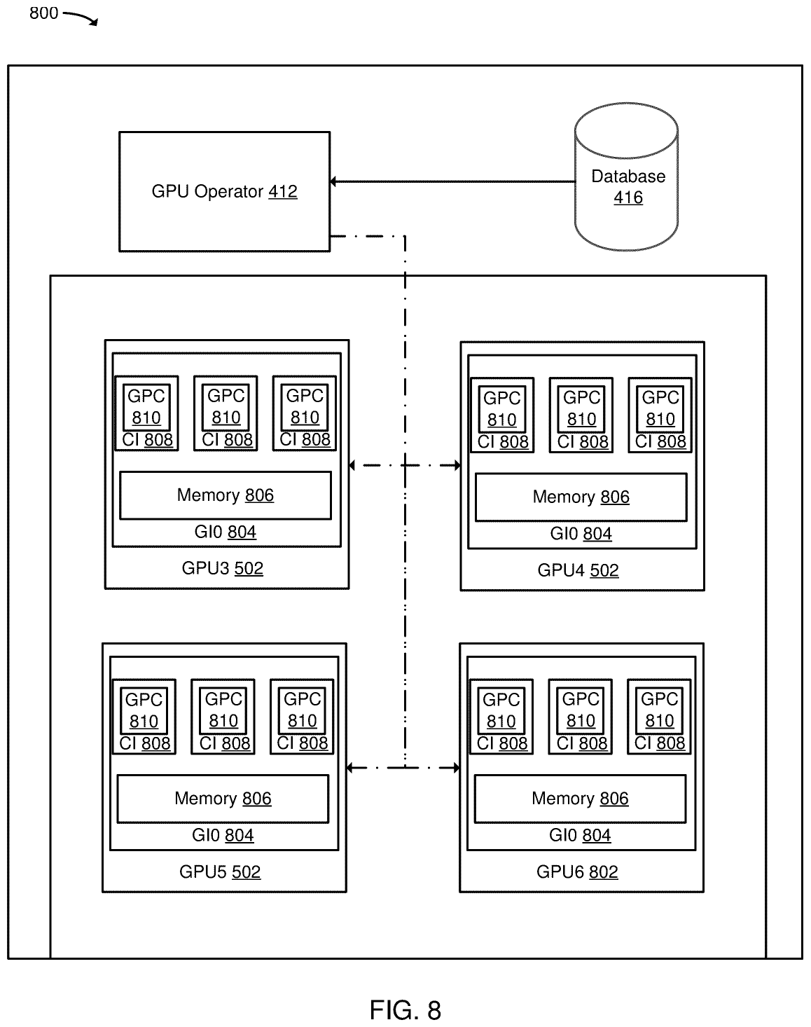

FIG. 8 shows a schematic diagram of multiple GPUs 502, 802 multiple GPU instances 804 being created according to configuration information retrieved from a database 416. Similar to FIG. 7, partition backups may also be utilized in instances where multiple GPUs 502, 802 lose partitions and must be restored. Once a node is back online following a reboot or some other form of loss of service, the GPU operator 412, acting as an agent, may retrieve configuration information from the database 416 in order to restore the GPU instances 804. Partition information may be stored in one or more files depending on user a user's needs.

The GPU operator 412 may utilize the configuration information to create new GPU instances 804 on each GPU 502, 802 that match the configuration of the GPU instances previously utilized by the GPUs 502, 802 without then need for user intervention. The GPU operator 412 may also instruct a GPU 802 newly added to the node to create a GPU instance 804 similar in configuration to the GPU instances 804 utilized by other GPUs 502, 802 within the node. A user may thus utilize GPU partition backups not only to restore functionality to rebooted nodes already on a cluster, but also to rapidly deploy more GPUs to a system according to a user's needs.

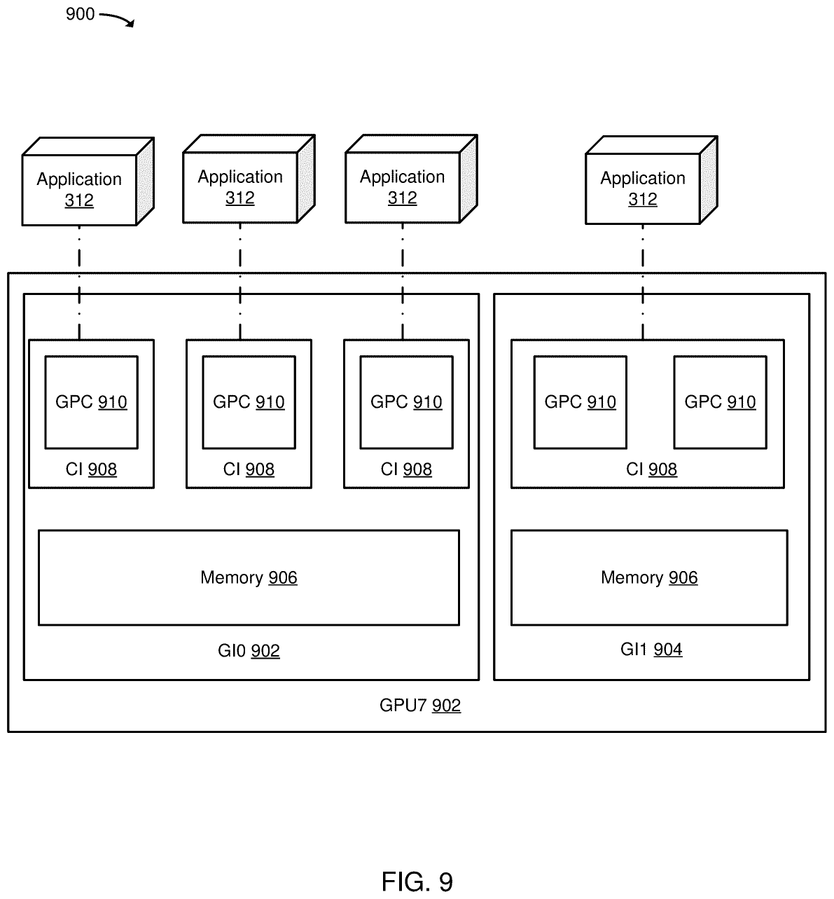

FIG. 9 shows a diagram of a newly rebooted GPU 902 with GPU instances 904 being mapped to applications 312. The GPU 902 may comprise GPU instances 902, 904 according to information retried from a configuration file as shown in FIG. 7 or 8. The node may still have applications that were suspended due to the reboot. After recreating the GPU instances 902, 904, the compute instances 908 will need to again be mapped to the applications 312 that previously used them. A GPU operator (not shown) may perform these mappings to get the applications 312 on the node back online. Applications 312 may utilize compute instances 908 on a one-to-one mapping basis in some implementations. Each compute instance 908 may comprise one GPC, or in some implementations comprise multiple according to an application's 312 needs.

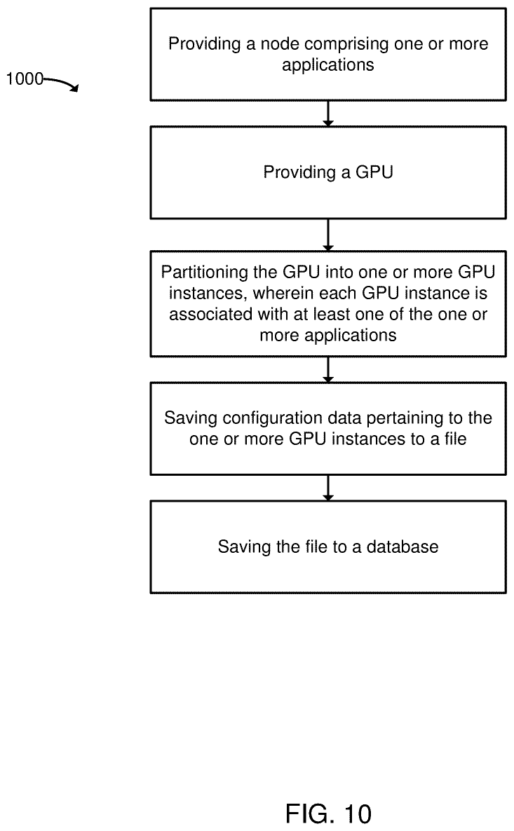

FIG. 10 is a flowchart diagram showing method steps for performing a GPU partition backup. The steps may include providing a node comprising one or more applications. The steps may further include providing a GPU. The steps may further include dividing the GPU into one or more GPU instances, wherein each GPU instance is associated with at least one of the one or more applications. The steps may further include saving partition data pertaining to the one or more GPU instances to a file. The steps may further include saving the file to a database.

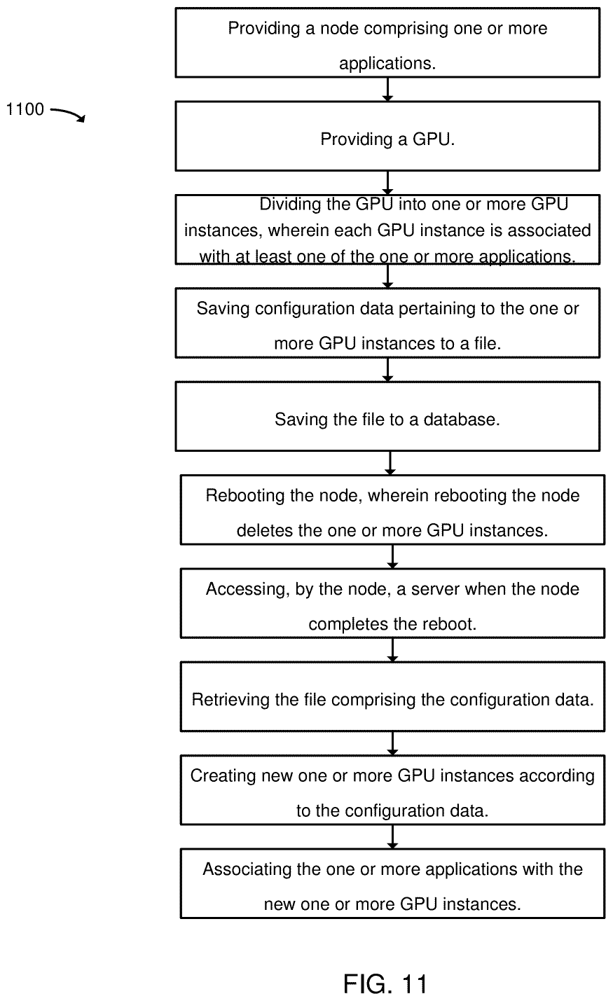

FIG. 11 is a flowchart diagram showing method steps for backing up partition data to a database and retrieving that partition data to create new GPU partitions. The steps may include providing a node comprising one or more applications. The steps may further include providing a GPU. The steps may further include dividing the GPU into one or more GPU instances, wherein each GPU instance is associated with at least one of the one or more applications. The steps may further include saving configuration data pertaining to the one or more GPU instances to a file. The steps may further include saving the file to a database. The steps may further include rebooting the node, wherein rebooting the node deletes the one or more GPU instances. The steps may further include accessing, by the node, a server when the node completes the reboot. The steps may further include retrieving the file comprising the configuration data. The steps may further include creating new one or more GPU instances according to the configuration data. The steps may include associating the one or more applications with the new one or more GPU instances.

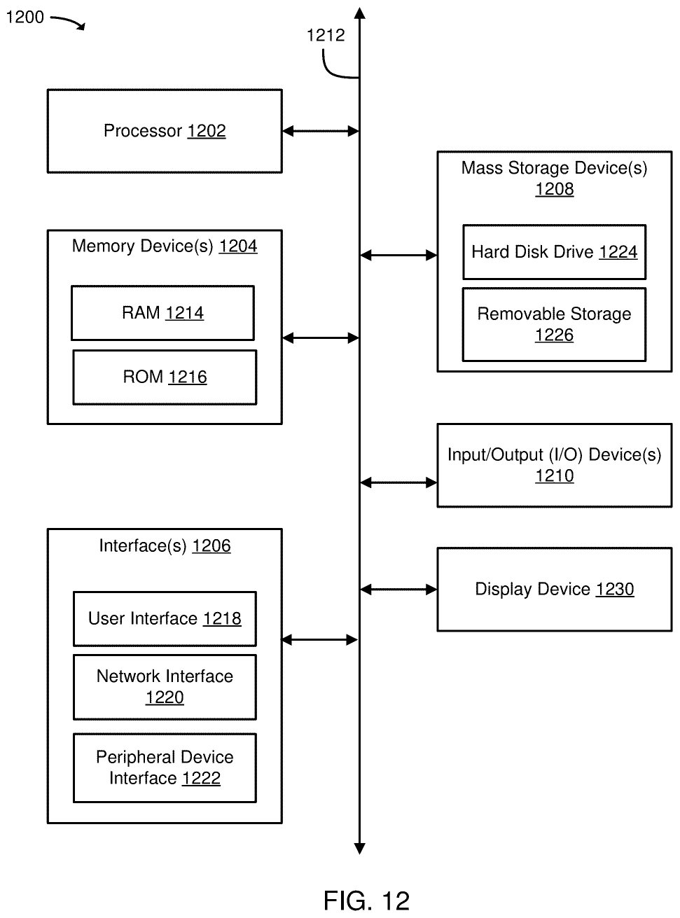

FIG. 12 illustrates a schematic block diagram of an example computing device 1200. The computing device 1200 may be used to perform various procedures, such as those discussed herein. The computing device 1200 can perform various monitoring functions as discussed herein, and can execute one or more application programs, such as the application programs or functionality described herein. The computing device 1200 can be any of a wide variety of computing devices, such as a desktop computer, in-dash computer, vehicle control system, a notebook computer, a server computer, a handheld computer, tablet computer and the like.

The computing device 1200 includes one or more processor(s) 1202, one or more memory device(s) 1204, one or more interface(s) 1206, one or more mass storage device(s) 1208, one or more Input/output (I/O) device(s) 1210, and a display device 1230 all of which are coupled to a bus 1212. Processor(s) 1204 include one or more processors or controllers that execute instructions stored in memory device(s) 1204 and/or mass storage device(s) 1208. Processor(s) 1204 may also include several types of computer-readable media, such as cache memory.

Memory device(s) 1204 include various computer-readable media, such as volatile memory (e.g., random access memory (RAM) 1214) and/or nonvolatile memory (e.g., read-only memory (ROM) 1216). Memory device(s) 1204 may also include rewritable ROM, such as Flash memory.

Mass storage device(s) 1208 include various computer readable media, such as magnetic tapes, magnetic disks, optical disks, solid-state memory (e.g., Flash memory), and so forth. As shown in FIG. 12, a particular mass storage device 1208 is a hard disk drive 1224. Various drives may also be included in mass storage device(s) 1208 to enable reading from and/or writing to the various computer readable media. Mass storage device(s) 1208 include removable media 1226 and/or non-removable media.

I/O device(s) 1210 include various devices that allow data and/or other information to be input to or retrieved from computing device 1200. Example I/O device(s) 1210 include cursor control devices, keyboards, keypads, microphones, monitors or other display devices, speakers, printers, network interface cards, modems, and the like.

Display device 1230 includes any type of device capable of displaying information to one or more users of computing device 1200. Examples of display device 1230 include a monitor, display terminal, video projection device, and the like.

Interface(s) 1206 include various interfaces that allow computing device 1200 to interact with other systems, devices, or computing environments. Example interface(s) 1206 may include any number of different network interfaces 1220, such as interfaces to local area networks (LANs), wide area networks (WANs), wireless networks, and the Internet. Other interface(s) include user interface 1218 and peripheral device interface 1222. The interface(s) 1206 may also include one or more user interface elements 1218. The interface(s) 1206 may also include one or more peripheral interfaces such as interfaces for printers, pointing devices (mice, track pad, or any suitable user interface now known to those of ordinary skill in the field, or later discovered), keyboards, and the like.

Bus 1212 allows processor(s) 1204, memory device(s) 1204, interface(s) 1206, mass storage device(s) 1208, and I/O device(s) 1210 to communicate with one another, as well as other devices or components coupled to bus 1212. Bus 1212 represents one or more of several types of bus structures, such as a system bus, PCI bus, IEEE bus, USB bus, and so forth.

For purposes of illustration, programs and other executable program components are shown herein as discrete blocks, such as block 1202 for example, although it is understood that such programs and components may reside at various times in different storage components of computing device 1200 and are executed by processor(s) 1202. Alternatively, the systems and procedures described herein, including programs or other executable program components, can be implemented in hardware, or a combination of hardware, software, and/or firmware. For example, one or more application specific integrated circuits (ASICs) can be programmed to carry out one or more of the systems and procedures described herein.

Various techniques, or certain aspects or portions thereof, may take the form of program code (i.e., instructions) embodied in tangible media, such as floppy diskettes, CD-ROMs, hard drives, a non-transitory computer readable storage medium, or any other machine readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Many of the functional units described in this specification may be implemented as one or more components, which is a term used to more particularly emphasize their implementation independence. For example, a component may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

### EXAMPLES

The following examples pertain to further embodiments.

Example 1 is a method. The steps include providing a node comprising one or more applications, providing a GPU; dividing the GPU into one or more GPU instances, wherein each GPU instance is associated with at least one of the one or more applications; saving partition data pertaining to the one or more GPU instances to a file, and saving the file to a database.

Example 2 is a method according to Example 1, further comprising rebooting the node, wherein rebooting the node deletes the one or more GPU instances, accessing, by the node, a server when the node completes the reboot, retrieving the file comprising the partition data, creating new one or more GPU instances according to the partition data, and associating the one or more applications with the new one or more GPU instances.

Example 3 is a method according to Examples 1 or 2, further comprising wherein dividing the GPU into one or more GPU instances, saving partition data pertaining to the one or more GPU instances to a file, and saving the file to a database are performed by an automated agent.

Example 4 is a method according to any of Examples 1-3, further comprising wherein retrieving the file comprising the partition data, creating new one or more GPU instances according to the partition data, and associating the one or more applications with the new one or more GPU instances are performed by the automated agent.

Example 5 is a method according to any of Examples 1-4, further comprising wherein the GPU is a plurality of GPUs and the plurality of GPUs each support one or more GPU instances, and wherein partition data of each GPU instance of each GPU is saved to the file.

Example 6 is a method according to any of Examples 1-5, further comprising wherein the node provides a handshake to the automated agent upon completing the reboot such that the automated agent receives an indication to retrieve the file from the server and partition the GPU.

Example 7 is a method according to any of Examples 1-6, further comprising wherein the agent saves the partition data to the file each time there is a change to a number of the GPU instances, a configuration of the GPU instances, or a mapping of the GPU instances.

Example 8 is a method according to any of Examples 1-7, wherein the partition data is periodically saved to the file according to a time period and saved to the database, and wherein the time period specified by a user.

Example 9 is a method according to any of Examples 1-8, wherein the partition data comprises one or more of a state of the GPU instances, a configuration of the GPU instances, metadata describing the GPU, or a ratio of the compute power in each GPU instance.

Example 10 is a method according to any of Examples 1-9, wherein accessing the server is performed by an automated agent, and wherein the automated agent performs the handshake to determine when the node finishes the reboot.

Example 11 is a system comprising a memory and one or more processors configured to execute programming instructions stored on a non-transitory computer readable storage medium, where executing the programming instructions causes the system to provide a node comprising one or more applications, provide a GPU, divide the GPU into one or more GPU instances, wherein each GPU instance is associated with at least one of the one or more applications, save partition data pertaining to the one or more GPU instances to a file, and save the file to a database.

Example 12 is a system according to Example 11, wherein executing the programming instructions further causes the system to reboot the node, wherein rebooting the node deletes the one or more GPU instances, access, by the node, a server when the node completes the reboot, retrieve the file comprising the partition data, create new one or more GPU instances according to the partition data, and associate the one or more applications with the new one or more GPU instances.

Example 13 is a system according to Examples 11 or 12, wherein dividing the GPU into one or more GPU instances, saving partition data pertaining to the one or more GPU instances to a file, and saving the file to a database are performed by an automated agent.

Example 14 is a system according to any of Examples 11-13, wherein retrieving the file comprising the partition data, creating new one or more partitions according to the partition data, and associating the one or more applications with the new one or more GPU instances are performed by the automated agent.

Example 15 is a system according to any of Examples 11-14, wherein the GPU is a plurality of GPUs and the plurality of GPUs each support one or more GPU instances, and wherein partition data of each GPU instance of each GPU is saved to the file.

Example 16 is a system according to any of Examples 11-15, wherein the node provides a handshake to the automated agent upon completing the reboot such that the agent receives an indication to retrieve the file from the server and partition the GPU.

Example 17 is a system according to any of Examples 11-16, wherein the agent saves the partition data to the file each time there is a change to the number of the GPU instances, a configuration of the GPU instances, or a mapping of the GPU instances.

Example 18 is a system according to any of Examples 11-17, wherein the partition data is saved to a cache, wherein the cache is periodically saved to the file and saved to the database, and wherein the time period is specified by the user.

Example 19 is a system according to any of Examples 11-18, wherein accessing the server is performed by an agent, and wherein the agent performs the handshake to determine when the node comes back online.

Example 20 is a non-transitory computer readable storage medium storing instructions for execution by one or more processors, the instructions comprising, providing a node comprising one or more applications, providing a GPU, dividing the GPU into one or more GPU instances, wherein each GPU instance is associated with at least one of the one or more applications, saving configuration data pertaining to the one or more GPU instances to a file, and saving the file to a database, rebooting the node, wherein rebooting the node deletes the one or more GPU instances, accessing, by the node, a server when the node completes the reboot, retrieving the file comprising the configuration data, creating new one or more GPU instances according to the configuration data, associating the one or more applications with the new one or more GPU instances.

What is claimed is:

1. A method comprising:
providing a node comprising one or more applications;
providing a GPU;
dividing the GPU into one or more GPU instances, wherein each GPU instance is associated with at least one of the one or more applications;
saving partition data pertaining to the one or more GPU instances to a file; and
saving the file to a database.

2. The method of claim 1, further comprising:
rebooting the node, wherein rebooting the node deletes the one or more GPU instances;
accessing, by the node, a server when the node completes the reboot;
retrieving the file comprising the partition data;
creating new one or more GPU instances according to the partition data; and
associating the one or more applications with the new one or more GPU instances.

3. The method of claim 2, wherein dividing the GPU into one or more GPU instances, saving partition data pertaining to the one or more GPU instances to a file, and saving the file to a database are performed by an automated agent.

4. The method of claim 3, wherein retrieving the file comprising the partition data, creating new one or more partitions according to the partition data, and associating the one or more applications with the new one or more GPU instances are performed by the automated agent.

5. The method of claim 1, wherein the GPU is a plurality of GPUs and the plurality of GPUs each support one or more GPU instances, and wherein partition data of each GPU instance of each GPU is saved to the file.

6. The method of claim 3, wherein the node provides a handshake to the automated agent upon completing the reboot such that the automated agent receives an indication to retrieve the file from the server and partition the GPU.

7. The method of claim 6, wherein the automated agent saves the partition data to the file each time there is a change to a number of the GPU instances, a configuration of the GPU instances, or a mapping of the GPU instances to the one or more applications.

8. The method of claim 1, wherein the partition data is periodically saved to the file according to a time period and saved to the database, and wherein the time period is specified by a user.

9. The method of claim 1, wherein the partition data comprises one or more of a state of the GPU instances, a configuration of the GPU instances, metadata describing the GPU, or a ratio of the compute power in each GPU instance.

10. The method of claim 2, wherein accessing the server is performed by an automated agent, and wherein the automated agent provides a handshake to determine when the node finishes the reboot.

11. A system comprising a memory and one or more processors configured to execute programming instructions stored on a non-transitory computer readable storage medium, where executing the programming instructions causes the system to:
provide a node comprising one or more applications;
provide a GPU;
divide the GPU into one or more GPU instances, wherein each GPU instance is associated with at least one of the one or more applications;
save partition data pertaining to the one or more GPU instances to a file; and
save the file to a database.

12. The system of claim 11, wherein executing the programming instructions further causes the system to:
reboot the node, wherein rebooting the node deletes the one or more GPU instances;
access, by the node, a server when the node completes the reboot;
retrieve the file comprising the partition data;
create new one or more GPU instances according to the partition data; and
associate the one or more applications with the new one or more GPU instances.

13. The system of claim 12, wherein dividing the GPU into one or more GPU instances, saving partition data pertaining to the one or more GPU instances to a file, and saving the file to a database are performed by an automated agent.

14. The system of claim 13, wherein retrieving the file comprising the partition data, creating new one or more partitions according to the partition data, and associating the one or more applications with the new one or more GPU instances are performed by the automated agent.

15. The system of claim 11, wherein the GPU is a plurality of GPUs and the plurality of GPUs each support one or more GPU instances, and wherein partition data of each GPU instance of each GPU is saved to the file.

16. The system of claim 13, wherein the node provides a handshake to the automated agent upon completing the reboot such that the automated agent receives an indication to retrieve the file from the server and partition the GPU.

17. The system of claim 16, wherein the automated agent saves the partition data to the file each time there is a change to a number of the GPU instances, a configuration of the GPU instances, or a mapping of the GPU instances.

18. The system of claim 11, wherein the partition data is periodically saved to the file according to a time period and saved to the database, and wherein the time period is specified by the user.

19. The system of claim 12, wherein accessing the server is performed by an automated agent, and wherein the automated agent provides a handshake to determine when the node comes back online.

20. Non-transitory computer readable storage medium storing instructions for execution by one or more processors, the instructions comprising:
providing a node comprising one or more applications;
providing a GPU;
dividing the GPU into one or more GPU instances, wherein each GPU instance is associated with at least one of the one or more applications;
saving configuration data pertaining to the one or more GPU instances to a file;
saving the file to a database;
rebooting the node, wherein rebooting the node deletes the one or more GPU instances;
accessing, by the node, a server when the node completes the reboot;
retrieving the file comprising the configuration data;
creating new one or more GPU instances according to the configuration data; and
associating the one or more applications with the new one or more GPU instances.
